(19) United States
(12) Patent Application Publication
(10) Pub. No.: US 2018/0050576 A1
(43) Pub. Date: Feb. 22, 2018

(54) METHOD FOR CONTROLLING A HEATING, VENTILATION AND AIR CONDITIONING SYSTEM OF A VEHICLE

(71) Applicant: FORD GLOBAL TECHNOLOGIES, LLC, Dearborn, MI (US)

(72) Inventor: Dietmar Boehme, Duisburg (DE)

(21) Appl. No.: 15/668,409

(22) Filed: Aug. 3, 2017

(30) Foreign Application Priority Data
Aug. 17, 2016 (DE) 102016215395.1

(51) Int. Cl. B60H 1/00

(52) U.S. Cl. CPC B60H 1/00828; G05D 23/1917; B60H 1/00735

(57) ABSTRACT

In a method for controlling a heating, ventilation and air conditioning system of a vehicle, a total air flow is generated by means of a fan. The total air flow is divided into partial air flows which are conducted via outlet openings into several selected zones of a vehicle cab of the vehicle. Furthermore, a predefined proportion of the total air flow is set as a partial air flow, wherein the predefined proportion is established using a manually operated, central control device of the heating, ventilation and air conditioning system. A corresponding heating, ventilation and air conditioning system for a vehicle is also described.

### TECHNICAL FIELD

This document concerns a method for controlling a heating, ventilation and air conditioning system of a vehicle, and also a heating, ventilation and air conditioning system for a vehicle.

### BACKGROUND

In conventional heating, ventilation and air conditioning systems (HVAC systems) for vehicles, in particular for motor vehicles, air is conducted into a vehicle cab or passenger compartment with adjustable fan power and temperature. As well as automatic operation of the HVAC system, usually a manual selection is possible of one or more zones of the vehicle into which the air flow generated by the fan is conducted. Examples of such zones of the vehicle cab are a footwell, an upper body zone and a front windscreen zone. A supply of air into one zone can be switched on or off using a central operating and control device. If several zones are selected simultaneously, the air flow generated by the fan is divided into a partial air flow for each selected zone. These partial air flows can only be adjusted further for specific zones by means of correspondingly formed outlet vents. Thus for the upper body zone, several outlet vents with adjustable outlet direction and outlet choking are distributed around the vehicle cab.

U.S. Pat. No. 5,833,133 A describes, for example, an HVAC system with a semi-automatic control system. The control system comprises a rotary knob for manual adjustment of the fan power and air temperature. Furthermore, a rotary knob is provided for switching the ventilation on and off and for selecting specific zones of the vehicle cab into which an air flow should be directed. Selection can be made between a footwell area, a front windscreen area, an upper body area together with the footwell area, and the front windscreen area together with the footwell area. The HVAC system furthermore comprises a microprocessor for controlling the air temperature and fan power taking into account various operating parameters, such as for example a set temperature, an ambient temperature, an interior temperature, a sunlight intensity and an engine coolant temperature.

The known HVAC systems allow, in addition to adjustment of the temperature and fan power, only very restricted regulation of the air flows conducted into the vehicle interior. For various zones of the vehicle cab, an air supply can only be switched on or off. If several zones are selected, the total air flow generated by the fan is distributed by opening supply lines into each of these zones. A user can normally influence the strength of such a partial air flow only for the upper body zone and then awkwardly, directly at the outlet vents. If for example the user has selected a front windscreen zone for deicing and a footwell, the strength of the air supply to the footwell can only be adjusted by changing the fan power. However, the air supply to the front windscreen area is always also changed.

One object of the present document is therefore to propose a method for controlling a heating, ventilation and air conditioning system of a vehicle, and also a heating, ventilation and air conditioning system for a vehicle, which avoid or at least reduce the above-mentioned disadvantages and in particular allow the air supply to the vehicle cab to be adapted to the user's needs more precisely and more easily.

In the method for controlling a heating, ventilation and air conditioning system of a vehicle, a total air flow is generated by means of a fan. The method is configured in particular for motor vehicles. The fan uses, for example, air either from the environment of the vehicle or from a vehicle cab to generate a total air flow. Preferably, the total air flow is heated or cooled to a predefined temperature before or after passing over the fan. For this, temperature values from one or more temperature sensors may be evaluated and taken into account.

The total air flow is divided into partial air flows which are conducted into several selected zones of a vehicle cab or passenger cell of the vehicle via outlet openings. These zones are for example horizontally delimited zones such as a footwell zone, an upper body zone or a head zone; vertically delimited zones such as for example a window zone, in particular a front windscreen zone, a driver's zone, a front passenger's zone and a rear zone; or zones with a combination of these limits. In each case, a partial air flow from the total air flow generated by the fan emerges via one or more outlet vents into each selected zone. The total air flow is divided over the selected zones or the outlet openings of the zones by a distribution device. For this, the distribution device contains air ducts, for example pipes or channels which are connected together via branches.

Furthermore, a predefined proportion of the total air flow is set as a partial air flow. For this, choke elements such as flaps may be provided in the air ducts or in the branches. Preferably, the choke elements may have not only an opened and a closed position but also one or more intermediate positions, or be able to be set at any point between a closed and a fully open state. Depending on the set opening of the choke elements, these allow a smaller or larger proportion of the total air flow to pass. Here, the total air flow can be described as an air volume emitted by the fan per time unit. The partial air flows then comprise proportions of this air volume per time unit.

The predefined proportion of the total air flow is established as a partial air flow using a manually operated, central control device of the heating, ventilation and air conditioning system. The central control device constitutes a user interface of the HVAC system and is arranged within the driver's reach, for example on the dashboard or a center console of the vehicle. Preferably, the proportions of the total air flow are established as partial flows by means of the control device for all selected zones into which partial air flows are conducted. For manual operation, the control device comprises for example rotary knobs, buttons, soft keys or a touchscreen.

In other words, using the current method, an air flow into a selected zone cannot only be activated or deactivated, but also a ratio of the partial air flow to the partial air flows for the other zones or to the total air flow can be set. In this way, an air flow into the passenger cell can be adapted optimally to the needs of a driver or passenger.

According to a preferred embodiment, predefined proportions for partial air flows for different zones of the vehicle cab are depicted on a display. The display is for example formed as an electronic display with light-emitting diodes, as a liquid crystal display or as a fluorescence display. The display may also comprise a flat screen, a touch-sensitive screen (touchscreen) or a head-up display which, as well as the proportions of partial air flows, show further information on the HVAC system or on the vehicle.

The predefined proportions of partial air flows are displayed on the display for the user e.g. digitally, such as in percentages or successive integer values, or graphically, for example as a bar or pie diagram. Alternatively or in addition to the predefined proportions, current actual values may be displayed which are for example determined by means of sensors or transmitted flap positions of the distribution device. Using the display, a user can be informed at any time of the proportions of the partial air flows or the distribution of the air flow, and make any desired changes.

In a further advantageous embodiment, to establish proportions, several values between a minimum value and a maximum value are predefined for selection. One of the predefined values is selected by means of the central control device which is configured accordingly for this. The minimum value is for example a zero proportion (0%) of the total air flow, and the maximum value is the total air flow (100%). However, for both the minimum value and the maximum value, other predefined extreme values for certain partial air flows may be provided depending on the ambient temperature or other vehicle parameters. For example, with an exterior temperature of less than 4° C., the minimum value for a front screen zone may be 20% of the total air flow.

Preferably, at least three equidistant values are predefined between the minimum value and the maximum value for partial air flow proportions. Starting from the minimum value, for example values may be predefined in steps of 25%, 10% or 5%. Also, for various partial air flows, a different number of values or step widths between these extreme values may be predefined. By establishing possible adjustment values in this way, as well as ensuring clear and easily comprehensible operation, it is easier to generate the respective selected proportions.

In a preferred embodiment, when a proportion for one partial air flow is increased, another partial air flow is selected and its proportion of the total air flow is reduced. The partial air flow to be reduced is preferably selected by the HVAC system using rules previously established. In one embodiment, the rules may be set at least partially by a user via the control device. For example, one or more user profiles for different users are provided which contain, as well as these rules, further user-specific parameters and values for the HVAC system. Accordingly, when a partial air flow is reduced by the user, another partial air flow is selected by the HVAC system for increase. With these measures, operation of the HVAC system is comfortable and rapid.

According to an advantageous embodiment, amongst the other partial air flows, the partial air flow with the largest proportion of the total air flow is selected for reduction. Preferably, in the case of two or more partial air flows with the same proportion, a selection for reduction is made following an established priority or at random. Alternatively, a partial air flow may be reduced following a predefined order. In further embodiments, the procedure is similar on manual reduction of a partial air flow proportion, and a partial air flow with a smallest proportion is selected for increase by the HVAC system. Since a user frequently finds it disruptive to have too little air flowing into one zone of the passenger cell while the ventilation in another zone is too strong, in this way the air supply can be adapted to the user's needs very easily just by increasing a proportion of the partial air flows.

In a further advantageous embodiment, on selection of a partial air flow for reduction, an environmental parameter or a vehicle state is taken into account. For example, the environmental parameter is an exterior temperature, relative humidity, type of precipitation, quantity of precipitation, fog density, sunlight intensity and similar in the environment of the vehicle. The vehicle state is, for example, an interior temperature, interior relative humidity, operating duration of the vehicle or similar. In particular, a partial air flow is not selected for reduction if, based on one or more of the above-mentioned environmental parameters or vehicle state values, operation of the vehicle is or could be restricted e.g. by condensation or icing of the front windscreen or side windows. Restrictions on the vehicle use or operating safety arising from the adjustment of partial air flow proportions are effectively avoided.

Preferably, if the exterior temperature is below a limit value, the proportion of the total air flow for deicing of a front windscreen is not reduced below a minimum proportion. The limit value of the exterior temperature is for example 4° C. or 0° C. The minimum proportion is a proportion sufficient for deicing. The minimum proportion may be established variably by the HVAC system depending on the exterior temperature or other environmental parameters. In particular, the minimum proportion is 30%, 20% or 10% of the total air flow. In this way, icing of the front windscreen due to a manual increase of a proportion of a total air flow is effectively prevented.

A heating, ventilation and air conditioning system for a vehicle comprises a fan for generating a total air flow, a distribution device for dividing the total air flow into partial air flows for several selected zones of a vehicle cab, and outlet openings for conducting the partial air flows into the selected zones. The distribution device is configured for setting a predefined proportion of the total air flow as a partial air flow. Furthermore, a manually operated, central control device is provided for establishing the predefined proportion.

Preferably, the HVAC system comprises a heater, a cooling system and temperature sensors for heating or cooling the total air flow before conduction into the vehicle cab. The distribution device contains for example pipes or channels formed as air ducts, which are connected together via branches and conduct the partial air flows to the outlet vents of the various zones. Furthermore, the distribution device may comprise choke elements such as flaps, which have not only a fully open and a closed end position but also several intermediate positions, or can be set at any point between these end positions. The choke elements allow a smaller or a larger proportion of the total air flow to pass depending on position. The proportions are for example proportions of an air volume emitted by the fan per time unit. The central control device contains, for manual setting of partial air flow proportions, e.g. rotary knobs, buttons, soft keys or a touchscreen.

In the same way as in the method, by using the HVAC system, it is possible to switch on or off a partial air flow for a selected zone. It is also possible to adjust the ratio to other partial air flows or to the total air flow. The air supply to the vehicle cab can thus be adapted very well to the needs and wishes of the driver or passengers.

In particular, a heating, ventilation and air conditioning system is configured for performance of a method as described above.

Further embodiments of the HVAC system for a vehicle correspond to the embodiments described of the method for controlling an HVAC system and have corresponding features and advantages.

### BRIEF DESCRIPTION OF THE DRAWING FIGURES

The method and system are now described below in more detail as an example with reference to the drawings. The drawings show:

FIG. 1 a diagrammatic extract of an exemplary embodiment of an HVAC system with a control device and a display,

FIG. 1a a schematic block diagram of the heating, ventilation and air conditioning system,

FIG. 2 a simplified flow diagram of an exemplary embodiment of a method according to the invention, and

FIG. 3a-h a diagrammatic depiction of an extract of a display of the exemplary embodiment according to FIG. 1 in various operating states.

### DETAILED DESCRIPTION

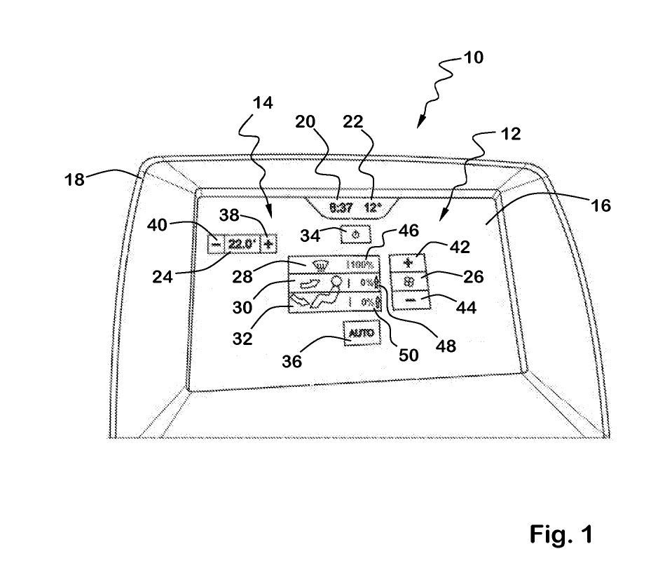

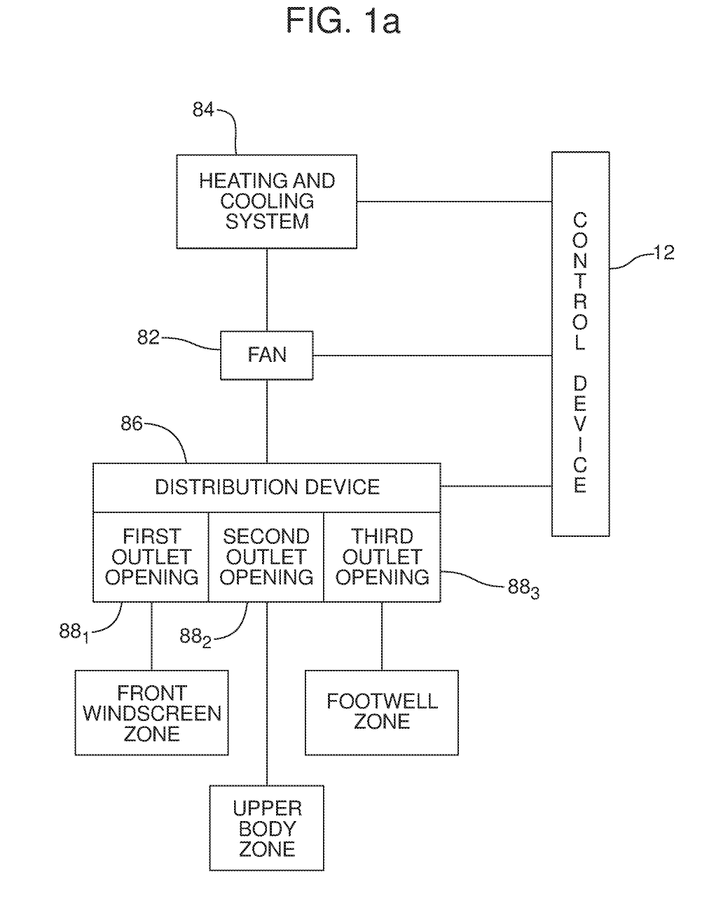

FIG. 1 shows diagrammatically an extract of an HVAC system 10. This shows a control device 12 and a display 14 which are formed by means of a touchscreen 16. The touchscreen 16 is arranged in a dashboard 18 of the motor vehicle, easily within the reach of a driver. In alternative embodiments, the display may comprise a screen, a head-up display, liquid crystal elements, fluorescence elements, light-emitting diodes or similar. The control device 12 then comprises for example rotary knobs, buttons or keys for entering values and changing operating states of the HVAC system 10.

The HVAC system 10 furthermore comprises components shown in FIG. 1a, such as a fan 82 for generating a total air flow for a vehicle cab or passenger cell, a heater and a cooling system 84 for tempering the total air flow to a predefined temperature, and a distribution device 86 with air pipes, air ducts and branches for conducting partial air flows of the total air flow via outlet openings or vents 88₁-88₃ into a footwell zone, an upper body zone and a front windscreen zone. As well as these three zones, further horizontal zones may be provided such as a head zone, or vertically separated zones such as for example a driver's zone, a passenger's zone or a rear zone (all not shown). In particular, the distribution device 86 comprises choke elements, for example flaps, which—depending on control setting—can assume not only a first closed end position and a second fully open end position, but also several further intermediate positions, each with different passage opening for partial air flows. With the choke elements, the air volume per time unit and hence the proportion of the total air flow for each of the partial air flows can be adjusted. A specific proportion of the total air flow is conducted into each of the three zones depending on the setting of the choke elements. Furthermore, an electronic control device is provided for controlling the choke elements and the other components of the HVAC system 10.

The display 14 comprises a display field for the current time 20, an exterior temperature 22, a set interior temperature 24, and a code for a fan power 26. The display 14 also contains a display field for each of the predefined proportions of the partial air flow. Note the front windscreen zone display field 28, the upper body zone display field 30 and the footwell zone display field 32. As shown in FIG. 1, the proportion of the total air flow for the partial air flow for the front windscreen zone is currently 100%, while the proportions of the total air flow for the partial air flows for the upper body zone and the footwell zone each amount to 0% and hence are switched off. The display furthermore contains other display fields (not shown), for example for values and settings of a seat heater, a parking heater and similar. Depending on the operating state of the HVAC system 10 or actuation of the control device 12 by a user, a position, arrangement or form of display fields can also be changed by the control device.

The control device 12 contains control elements for switching the HVAC system 10 on or off (note control element 34), for activating or deactivating (note control element 36) an automatic regulation of the HVAC system 10, for increasing the predefined interior temperature (note control element 38), for reducing the predefined interior temperature (note control element 40), for increasing the fan power (note control element 42) and hence the total air flow, and for reducing the fan power (note control element 44). Furthermore, the control device contains a respective control element for increasing the proportion of the total air flow for the partial air flow for the front windscreen zone (note control element 46), for the upper body zone (note control element 48) and for the footwell zone (note control element 50). Amongst these control elements, in the state of the HVAC system 10 shown in FIG. 1, only those for the partial air flow for the upper body zone 48 and footwell zone 50 are activated, since the proportion of the total air flow for the partial air flow for the front windscreen zone is already 100% and therefore no further increase is possible. This activation is depicted by arrow symbols for the user.

Every time one of the activated control elements for partial flows 48, 50 is touched, the corresponding proportion is increased by 10%. In alternative embodiments, other step widths may be provided, such as for example 25% or 5% per activation, or alternatively or additionally an actuatable reduction of proportions. The control device 12 sets the choke elements according to the proportions predefined by the user. In parallel with the increase in a proportion, another proportion is reduced by the control device following established rules. For example, the rules establish a minimum value for one or more proportions so that these proportions cannot be reduced below the minimum value. Environmental parameters, in particular an external temperature or operating values of the vehicle or HVAC system 10, may also be taken into account. In this way, as well as a fan power, the respective proportions of the total air flow for the partial air flows for the front windscreen zone, upper body zone and footwell zone can be adjusted easily using the HVAC system 10.

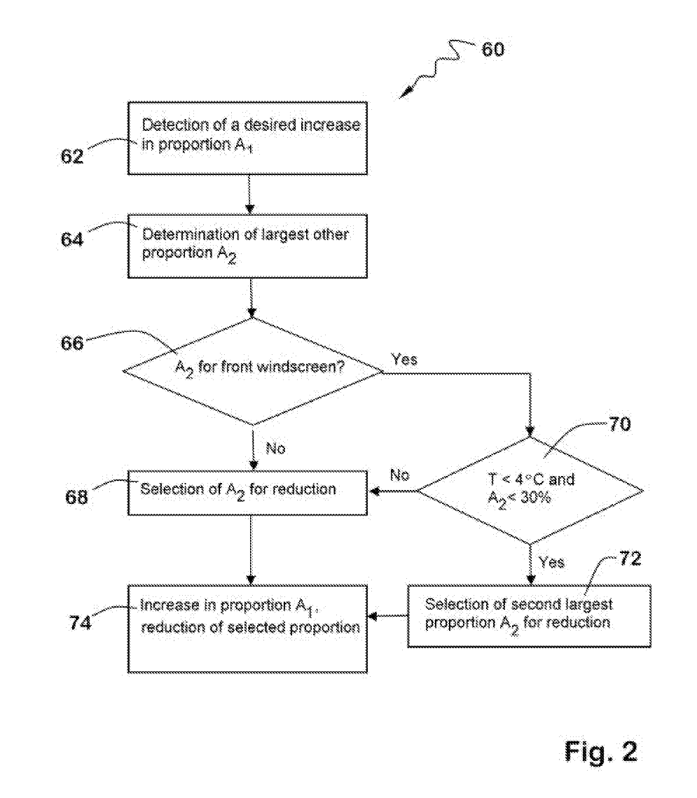

FIG. 2 shows a simplified flow diagram of an exemplary embodiment of the method 60. The function and interaction of the components of the HVAC system 10 according to FIG. 1 are described below together with the method according to FIG. 2. Firstly, the control device 12 sets the established starting values for the fan power, i.e. the total air flow, and for the proportion of the total air flow for the partial air flows to the front windscreen zone, footwell zone and upper body zone. When the automatic system is activated, these values are permanently regulated by the control device 12 taking into account measured sensor values and established setpoints.

If a user wishes to increase the proportion Ai, he activates the corresponding control element 46, 48, 50. The control device detects the desired increase, step 62. Then the largest proportion A2 amongst the other proportions is determined 64. If a check 66 of the largest proportion A2 determined shows that this proportion is not the partial air flow proportion for the front windscreen zone, the determined proportion A2 is selected for reduction 68. If the determined proportion A2 is the partial air flow proportion for the front windscreen zone, it is checked 70 whether an exterior temperature T is below 4° C. and the proportion A2 is less than 30% of the total air flow. If this is not the case, the proportion A2 is selected for reduction 68. Otherwise, the second largest proportion A3 amongst the proportions not provided for increase is selected 72 for reduction. Finally, the selected proportion is reduced by 10% and the 10% increase in proportion Ai desired by the user is made by the control device. For this, the control device 12 adjusts the choke elements of the distribution device accordingly. This prevents the partial air flow proportion for the front windscreen zone from being reduced below 20% if the exterior temperature is less than 4° C. Adequate deicing of the front windscreen is always guaranteed.

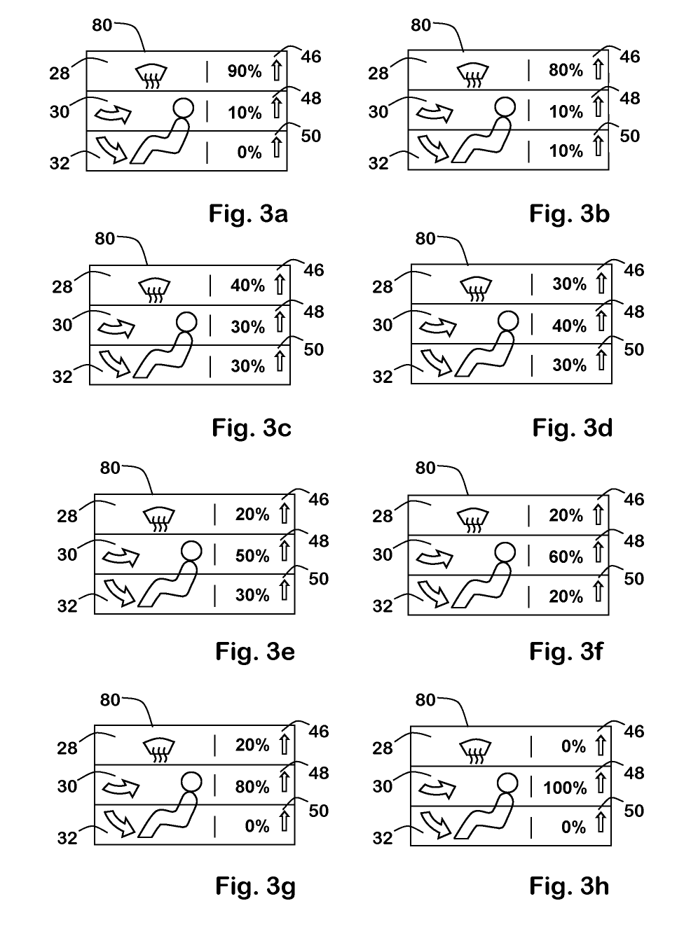

For further description of the method 60 according to FIG. 2 and the HVAC system 10 according to FIG. 1, FIGS. 3a to 3h each show a diagrammatic depiction of an extract 80 of the display 14 in various operating states. Starting from the setting of the partial air flow proportions according to FIG. 1 at 100% for the front windscreen zone and 0% for the upper body zone and footwell zone, the user activates the control element 48 to increase the partial air flow proportion for the upper body zone. Since the proportion for the front windscreen zone is greater than 20% and greater than the proportion for the footwell zone, the control device reduces the proportion to the windscreen zone by 10% and increases the proportion to the upper body zone by 10%. FIG. 3a shows this state. The display fields 28, 30, 32 each show the set proportion for the user.

According to FIG. 3b, by activating the control element 50, the user has increased the partial air flow proportion to the footwell by 10%. According to FIG. 3c, by repeated actuation of the control elements for the upper body zone 48 and footwell zone 50, the corresponding partial air flow proportions are each increased to 30% of the total air flow. Following the rule described above, the proportion for the front windscreen zone is reduced accordingly.

In FIG. 3d, the proportion for the upper body zone has been increased by a further 10% to 40% of the total air flow. The proportion for the front windscreen zone has been reduced accordingly to 30% and is now precisely as large as the proportion for the footwell zone. When the proportion for the upper body zone is increased again according to FIGS. 3e to 50% by activation of the control element 48, the control device selects from the two other proportions of the same size, following a predefined order, the front windscreen zone for reduction. The exterior temperature, other environmental parameters or operating states of the HVAC system or vehicle may be taken into account. Alternatively, a random selection is possible between two other proportions of the same size.

According to FIG. 3f, a further increase in the partial air flow proportion for the upper body zone has been made to 60%. Since in this case the exterior temperature lies below 4° C. and the partial air flow proportion for the windscreen zone is only 20%, on a further increase in the proportion for the upper body zone, only the partial air flow proportion for the footwell zone is reduced. According to FIG. 3g, when the exterior temperature is below 4° C., finally a maximum increase in the proportion for the upper body zone to 80% is reached, while the proportion for the front windscreen zone is 20% and the proportion for the footwell zone is 0%. FIG. 3h depicts an operating state at an exterior temperature above 4° C. The proportion of the partial air flow for the upper body zone has been increased to 100% by repeated actuation of the control element 48, while the two other proportions have been reduced to 0% and hence switched off.

Obvious modifications and variations are possible in light of the above teachings. All such modifications and variations are within the scope of the appended claims when interpreted in accordance with the breadth to which they are fairly, legally and equitably entitled.

What is claimed:

1. A method for controlling a heating, ventilation and air conditioning system of a vehicle, wherein a total air flow is generated by means of a fan and the total air flow is divided into partial air flows which are conducted via outlet openings into several selected zones of a vehicle cab of the vehicle, wherein
a predefined proportion of the total air flow is set as a partial air flow for one of said several selected zones, wherein the predefined proportion is established using a manually operated, central control device of the heating, ventilation and air conditioning system.

2. The method as claimed in claim 1,
wherein predefined proportions for said partial air flows for different zones of the vehicle cab are depicted on a display.

3. The method as claimed in claim 1,
wherein to establish proportions, several values between a minimum value and a maximum value are predefined for selection.

4. The method as claimed in claim 3,
wherein when a first proportion for one partial air flow is increased, a second proportion for another partial air flow is reduced.

5. The method as claimed in claim 4,
wherein amongst the partial air flows, the partial air flow with largest proportion of the total air flow is selected for reduction.

6. The method as claimed in claim 5,
wherein on selection of the partial air flow for reduction, an environmental parameter or a vehicle state is taken into account.

7. The method as claimed in claim 6,
wherein if an exterior temperature is below a limit value, a proportion of the partial air flow for deicing of a front windscreen is not reduced below a minimum proportion.

8. A heating, ventilation and air conditioning system for a vehicle, comprising a fan for generating a total air flow, a distribution device for dividing the total air flow into partial air flows for several selected zones of a vehicle cab, and outlet openings for conducting the partial air flows to the selected zones, wherein
the distribution device is configured for setting a predefined proportion of the total air flow as a partial air flow, and a manually adjustable central control device to establish the predefined proportion.
